(19) United States
(12) Patent Application Publication
(10) Pub. No.: US 2024/0386495 A1
(43) Pub. Date: Nov. 21, 2024

(54) Method and System For Portfolio Generation, Presentation, and Processing Using Machine Learning and Automated Processes

(71) Applicant: John Anthony Radosta, Fort Lauderdale, FL (US)

(72) Inventor: John Anthony Radosta, Fort Lauderdale, FL (US)

(21) Appl. No.: 18/199,447

(22) Filed: May 19, 2023

(51) Int. Cl. G06Q 40/06

(52) U.S. Cl. CPC G06Q 40/06

(57) ABSTRACT

A method for generating, presenting, and processing an investment portfolio, comprising of (a) receiving inputs from a user or external source, (b) generating insights via machine learning or automatic process, (c) generating an investment portfolio from said insights, (d) building the generated investment portfolio, (e) enriching the generated investment portfolio with data, and (f) presenting the generated investment portfolio back to the user. A system for generating, presenting, and processing an investment portfolio is also provided.

### BACKGROUND ON THE INVENTION

### 1. Field of the Invention

The present invention is related generally to investment research and portfolio analysis useful in the financial field.

More particularly, the present invention provides a unique capability that enables users to use natural language to generate, build, and evaluate investment portfolios by means of machine learning and automated processes.

The method and system described herein can accept user input to provide financial advisory and suggest portfolios containing assets, which the user can then build and data-enrich the suggested portfolios for the purpose of analyzing, modifying, and monitoring each portfolio's quantitative factors.

### 2. Description of the Prior Art

In the past, investment tools used to optimize, simulate, and evaluate the performance of a given investment portfolio have only been available to financial consultants and large institutional financial professionals.

These investors typically seek to maximize the expected return on an overall investment of client funds for a given level of risk using techniques known to persons skilled in portfolio management.

In recent years, an increasing number of individual or “retail” investors are attempting to directly manage their own portfolios without the benefit of a financial professional involved. In response, demand for portfolio analysis and investment research software is increasing.

In both cases, neither institutional nor retail investor portfolio analysis software has incorporated machine learning-specifically a subfield of machine learning known as natural language processing (NLP)—to suggest, generate, and build portfolios based on provided preferences such as risk tolerance or thematic investing style.

Several portfolio analysis methods have been developed in recent years to help individuals select the best financial products to meet their needs. These methods typically perform analysis and suggestion based upon pre-programmed responses.

However, these methods are based on specific investment products that are pre-programmed to be provided back to the user based on a decision tree-they do not utilize machine learning or other automatic processes to generate unique and custom-tailored insights every time.

Today, a new architecture within NLP is emerging known as generative large language models (LLMs). These models are capable of interpreting and responding to user questions and input with a high degree of context and accuracy in their answers. While this field is a burgeoning field, it has yet to be combined and incorporating with the ability to suggest, generate, and build portfolios for further analysis using data enrichment techniques.

Many individual investors also lack a basic knowledge of portfolio theory. They may have a general idea of what they have at risk but lack the fine-tuned ability to quantify their risk numerically and perform exacting, real, and useful analysis on their current set of investments.

Moreover, over 70% of individual U.S. investors today are not working with a financial advisor. Combine this with the fact that in the next 10 years, 40% of all current financial advisors will be retiring, it becomes clear that there is a need for a new form of financial advisory and portfolio analysis tools to assist investors in the investment decision process, both at the retail and the institutional level.

What is needed specifically is a powerful, yet accessible method that combines generative natural language processing and other automatic processes, that allows investors to pose inquiries to generate new thematic portfolio ideas that are automatically built, data-enriched, and presented back to them in a quantifiable manner.

Therefore, the method and system described herein serves for generating new investment insights, building investment portfolios, enriching those portfolios with external market data or information, and displaying them back to the user for further analysis, processing, modification, and monitoring.

Conventional financial analytical tools allow only for the creation of portfolios manually, meaning that the user must add every position into the portfolio manually. These tools also do not have any type of generative language ability that allow the user to ask financial questions and receive unique insights into their investment criteria.

These tools typically are also very basic and do not provide any type of quantitative analysis on risk and return with metrics such as Sharpe, Sortino, and Max Drawdown ratios.

Similarly, they also do no provide portfolio valuation metrics, or other unique insights based on the specific proportions of financial assets in each portfolio-nor do they incorporate the requisite data-enrichment techniques necessary to perform such analyses.

### BRIEF SUMMARY OF THE INVENTION

The present invention overcomes the aforementioned problems associated with conventional financial analysis methods by providing a method and system for generating, presenting, and processing an investment portfolio, comprising the steps of (a) receiving inputs from a user or external source, (b) generating insights via machine learning or automatic process, (c) generating an investment portfolio from said insights, (d) building the generated investment portfolio, (e) enriching the generated investment portfolio with data, and (f) presenting the generated investment portfolio back to the user for further analysis, processing, modification, and monitoring.

The present invention provides a unique method for instantly answering financial inquiries and generating investment portfolios based on user-provided criteria. The present invention also provides a unique method for automatically building and data-enriching the generated portfolios.

The present invention additionally provides analysis tools that allows the user to quantify asset and portfolio valuation, performance, risk, income, and investment style over the life of the portfolio.

The present invention also provides monitoring capabilities for the user to continuously monitor and receive notifications on the portfolio based on changes in market prices or portfolio metrics.

The present invention also provides ongoing analysis and generates insights as portfolio metrics and the market prices of contained assets fluctuate.

The present invention is an improvement on prior art due to its generative ability of financial insights based on user-provided input and market data enrichment. The present invention is iterative on prior art in that it provides non-financially sophisticated users the ability to generate portfolio ideas thematically in a safe and well-researched manner.

The present invention revolutionizes the research phase that precedes portfolio construction by empowering users with financial sophistication and knowledge they otherwise may not have at their disposal.

Moreover, the present invention eliminates the need to have to create portfolios by adding assets manually. Traditionally, a user would have to research an investment idea, create a portfolio, and then add that financial asset into the portfolio, one by one.

The present invention still provides that functionality but allows the user to use their own language to describe their investment criteria and financial inquiries, which in turn guides machine learning and other automated processes to suggest, build, data-enrich, and present the portfolio back to the user for further quantitative analysis.

The present invention provides for a novel approach that allows individual investors to research, generate, build, and analyze, and monitor many portfolios within seconds.

This provides the investor more thematic investment options for them to choose from that are custom-tailored to their own investment criteria and risk profile.

The present invention eliminates the industry-paradigm of creating cookie-cutter investment vehicles that investors are lumped into based on some generalized overlapping criteria.

The present invention's reason for embodiment is based on the principle that every investor's required investment criterion and risk profile differ from every other investor, even if only slightly.

The present invention also provides many additional advantages, which shall become apparent as described below.

### BRIEF DESCRIPTION OF THE DRAWINGS

FIG. 1 represents the system and its components which can be used to implement the method.

FIG. 2 is a diagram that represents all the input types that the method and system being described herein can accept in the preferred embodiment.

FIG. 3 is a diagram that represents all the output types that the method and system being described herein can return in the preferred embodiment.

FIG. 4 is diagram that shows an exploded view of all the subtypes of insights that can be delivered by the method and system from the output of FIG. 3.

FIG. 5 is a diagram that represents the different types of automatic or automated processes utilized within the method. The terms “automatic” or “automated” are used interchangeably, process and processes are also interchangeable.

FIG. 6 is a diagram representing an architecture of a machine learning model that is utilized by the system.

FIG. 7 is a diagram representing a variation of the machine learning model within the system that incorporates fine-tuning and reinforcement learning from human-assisted feedback.

FIG. 8 is a flowchart represent the user input flow and how information enters the method to generate outputs.

FIG. 9 is a flowchart representing the Build Portfolio process in FIG. 8 and the pertaining automatic processes that move the insights down through the method.

FIG. 10 is a flowchart representing the automatic processes that occur for the data enrichment of insights during the Portfolio Creation process as show in FIG. 9.

FIG. 11 is a flowchart depicting how the created portfolios are rendered and presented back to the user.

FIG. 12 is a diagram depicting how the data-enriched portfolio are displayed back to the user once the user has selected the portfolio in FIG. 11.

FIG. 13 is a diagram that shows the Portfolio Summary process of the data-enriched portfolio, as well as several automatic processes the user can then select to further alter and analyze the portfolio.

FIG. 14 is a diagram representing how the portfolio undergoes additional automatic processes when the user engages the Portfolio Insights module in FIG. 12.

FIG. 15 is a diagram representing how the portfolio undergoes additional automatic processes when the user engages the Valuation module in FIG. 12.

FIG. 16 is a diagram representing how the portfolio undergoes additional automatic processes when the user engages the Performance module in FIG. 12.

FIG. 17 is a diagram representing how the portfolio undergoes additional automatic processes when the user engages the Risk module in FIG. 12.

FIG. 18 is a diagram representing how the portfolio undergoes additional automatic processes when the user engages the Dividends module in FIG. 12.

FIG. 19 is a diagram representing how the portfolio undergoes additional automatic processes when the user engages the Notifications module in FIG. 12.

FIG. 20 is a flowchart showing a condensed flow of inputs and outputs within the method implemented by the system in preferred embodiment.

### DETAILED DESCRIPTION OF THE PREFERRED EMBODIMENT

Before proceeding with a description of the present invention, it is well to define certain terms as used herein.

Inputs: initial information that is passed into the method by the user.

Invention: the system and the method.

Outputs: information returned by the method that is contextual in nature to the inputs provided. Outputs can be of several different subtypes.

Automated or Automated Processes: processes that are pre-programmed to do specific tasks.

Portfolio: a portfolio is a collection of assets in a single container that has an appraisable cash value as a collection.

Financial Assets: assets that are financial by nature, such as stocks, bonds, treasuries, ETF's, ETN's, mutual funds, some types of real estate, cryptocurrencies, non-fungible tokens (NFTs), REITs, working interests, contractual rights, or other equity interests.

Physical Assets: assets that are physical in nature, art, property, precious metals, minerals, commodities, heirlooms, or real estate.

Liquid Assets: liquid assets are assets that have a liquidable value such as cash, insurance contracts, money market instruments, annuities, or intangible assets that have an appraisable cash value.

Textual Command/Inquiry: a textual input or question posed by a user.

Textual Response: a generic non-financial response that contains no financial insight, perhaps asking for additional input or just responding generically to the user.

Insights: an output that is considered of financial nature about an asset or assets. Examples of insights may include a description of Apple's company's current business operations, a portfolio suggestion, financial assets, liquid assets, or physical assets.

Data-Enriched: insights that have be augmented with external data, such as market data, price history, or other information. For example, an insight may be Apple stock, which is then data-enriched by augmenting that insight with Apple's stock price, daily percent price change, latest news, and other financial metrics.

Advisory: a textual response that is of financial nature, which may or may not contain an insight.

Remote Resource Procedure: a process that runs on a remote resource, as opposed to locally.

Scheduled Process: a process that runs on a regular or timed schedule.

Machine Learning: computer processes that can learn and adapt without following explicit instructions, by using algorithms and statistical models to analyze and draw inferences from patterns in data.

Machine Learning Model: the architectural implementation of machine learning within a system.

Input/Output Embedding: in machine learning, an input and output embedding is when text is converted into numerical data that is readable by a machine learning model.

Positional Encoding: describes the location or position of an entity in a sequence so that each position is assigned a unique representation.

Feed-Forward: a type of machine-learning model or network where data flows only in one direction.

Add & Norm: a process to improve machine learning during training where outputs are adding together with function such as f (x)+x and normalized to mute extreme output values.

Multi-Head Attention: a process that calculates score (called an attention score) for a machine learning model to control the mixing of information between pieces of an input sequence within parallel computation, leading to the creation of richer representations, which in turn allows for increased performance on machine learning tasks.

Masked Multi-Head Attention: when an attention score is calculated and combined on input sequences up to a current position and not on the whole input sequence. This is in stark difference from multi-head attention when an attention score is calculated for the whole input sequence.

Shifted-Right: a data manipulation technique that adjust a data set when its training and test distributions are different.

Linear: a linear function, such as the geometric linear function, y=mx+b.

Softmax: a function that converts vector of K real values into a vector of K real values that sum to one. In other words, a Softmax function provides a probability distribution for a set of values.

Output Probabilities: the percent change of a value occurring, such as the next word in a sentence. This does not refer to the outputs of the method being described herein but to the outputs of the machine learning model architecture, which are later furthered processed to outputs of the method.

Unsupervised Pre-Training: when machine learning learns a useful representation using a large amount of unlabeled data to facilitate the learning process.

Learning & Optimizing: a process that involves adjusting numerical weight biases within machine learning and optimizing them to return the lowest measurable loss as defined by an optimizer function.

Reinforcement Learning From Human Feedback: a technique that trains a “reward model” directly from human feedback and uses the model as a reward function to optimize an agent's policy using reinforcement learning.

Sharpe Ratio: divides a portfolio's excess returns by a measure of its volatility to assess risk-adjusted performance. It is defined as the difference between the returns of the investment and the risk-free return, divided by the standard deviation of the investment returns. It represents the additional amount of return that an investor receives per unit of increase in risk.

Sortino Ratio: measures the risk-adjusted return of an investment asset, portfolio, or strategy. It is a modification of the Sharpe ratio but penalizes only those returns falling below a user-specified target or required rate of return, while the Sharpe ratio penalizes both upside and downside volatility equally.

Calmar Ratio: measures the risk-adjusted return of an investment asset, portfolio, or strategy. It differs by Sortino or Sharpe ratio by using a portfolio's average compounded annual rate of return divided by its max drawdown.

Max Drawdown: a measure of an asset or portfolio's largest price drop from a peak to a trough; an indicator of downside risk.

Backtest Settings: backtesting is the process of analyzing a portfolio's returns over a period in the past. Backtest settings are things like start and end date for the backtest as well as the desired percent allocation for each holding in the portfolio.

Beta: a measure of risk that is based on the statistical variance of an asset's price movements.

Dividend: a regular cash or share payout for owning an asset.

Price Target: a price chosen by the user for an asset to be monitored to and notified upon reaching.

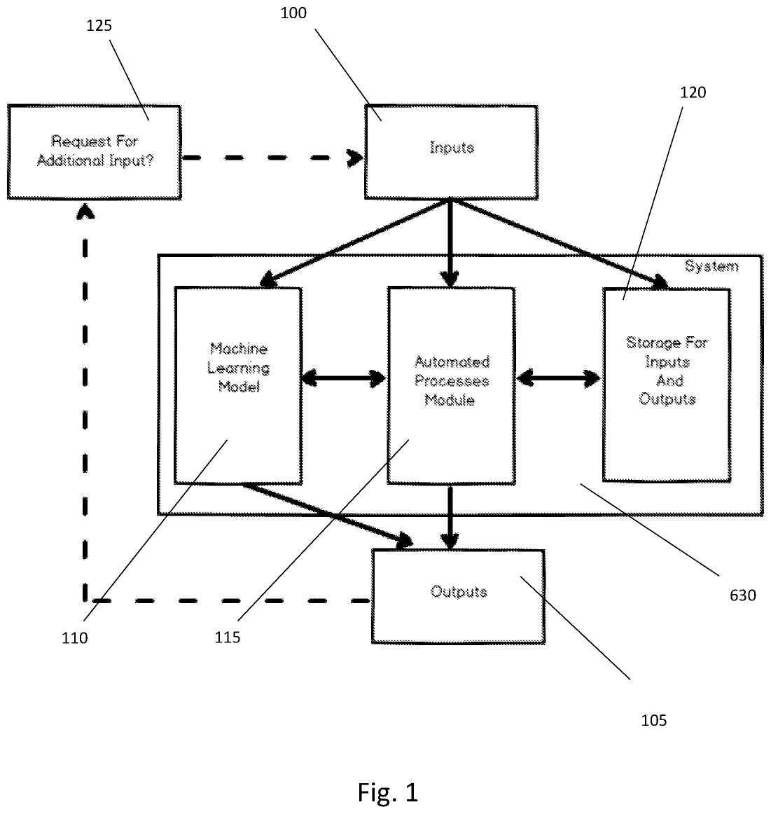

FIG. 1 shows the system 630 that is used to implement the method, consisting of a series of inputs 100 which are then directed to various components of the system 630. These component include a machine learning model 110 (which may be one or a collection of machine learning models as an ensemble), an automatic processes module or plurality of automatic processing modules 115, and a storage medium or plurality of storage mediums for inputs and outputs 120. The inputs 100 pass through the system 630 which generates outputs 105, of which said an output can prompt the user for additional inputs 125 or continue towards other automatic processes implemented by the system to be later described.

The system 630 used for implementing the method can vary in its component processes. For example, the machine learning model 110 could be removed completely, and outputs 105 could be generated solely via an automatic processes module 115.

Another variation may be that machine learning model 110 is replaced with another user of the system on the receiving end (such as a human financial advisor) which would then generate outputs 105 in place of the machine learning model 110. While these variations would not implement the invention in the preferred embodiment, the system components are interchangeable.

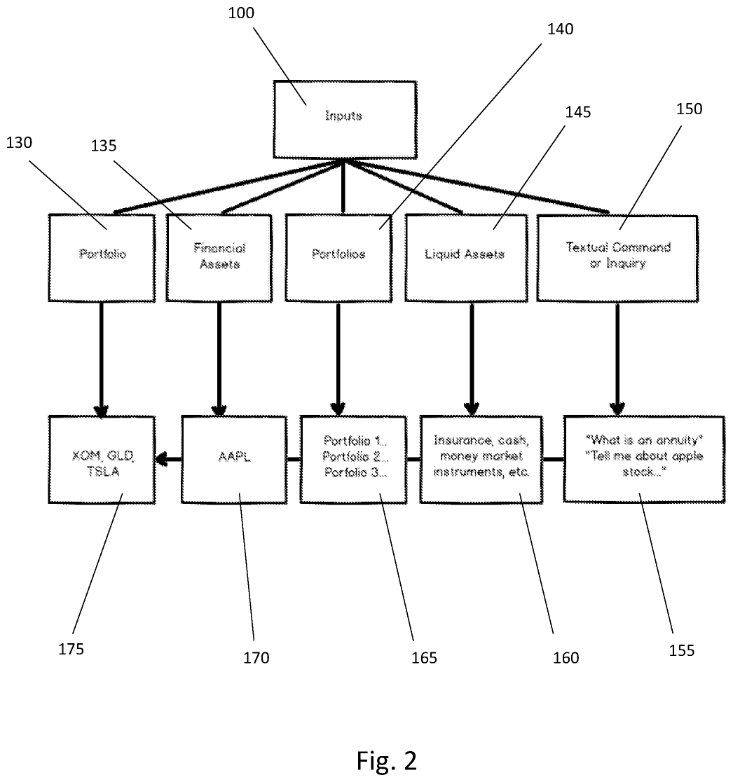

FIG. 2 shows a more specific exploded view of what constitutes inputs 100 within the context of the invention. Inputs 100 may include a portfolio 130, financial assets 135, liquid assets 145, or a plurality of portfolios 140. Inputs 100 may also consist of a simple textual command or inquiry 150. Inputs 100 can be user-generated or from external source such as another internet website or external source. For example, a portfolio synced from a brokerage account into the invention would constitute as an input portfolio 130 as well as if the user provided the contents of the portfolio 130 via textual command 150.

FIG. 2 also shows several examples of textual commands 155, liquid assets 160, portfolios 165, financial assets 170, and a portfolio of financial assets 175. Anticipated variations of inputs 100 may also include physical assets such as real estate, metals, heirlooms, commodities, fine art, cryptocurrencies, non-fungible tokens (NFTs), working interests such as oil rights, contracts, or intangible assets with an appraisable cash value.

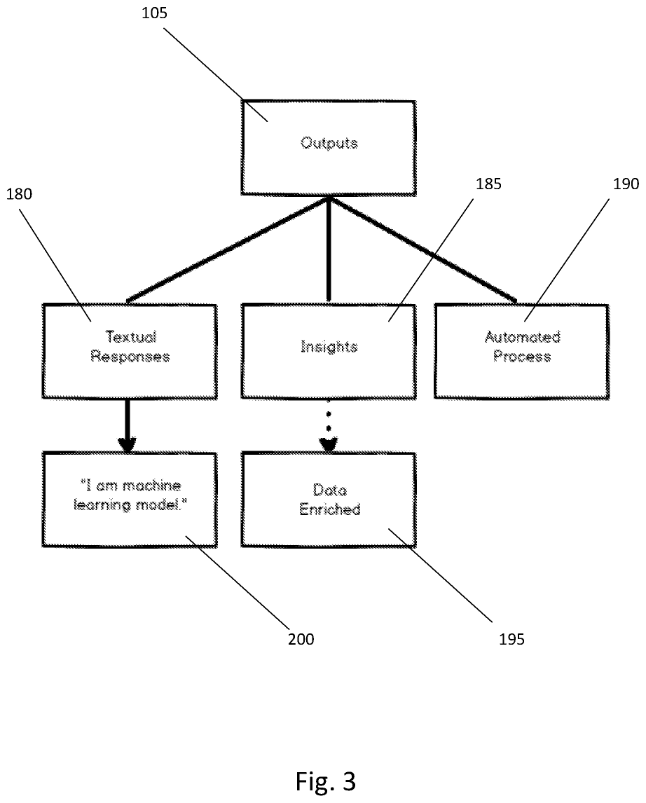

FIG. 3 shows a more specific exploded view of what constitutes outputs 105 within the context of the invention. These may include textual responses 180, an automatic or automated process or processes 190, or insights 185 which will be further described in proceeding figures. Insights 185 may be in raw textual form, or they may be data-enriched 195. An example of a textual response is also provided 200. Insights 185 and their subsequent data-enrichment 195 are key aspects of the method.

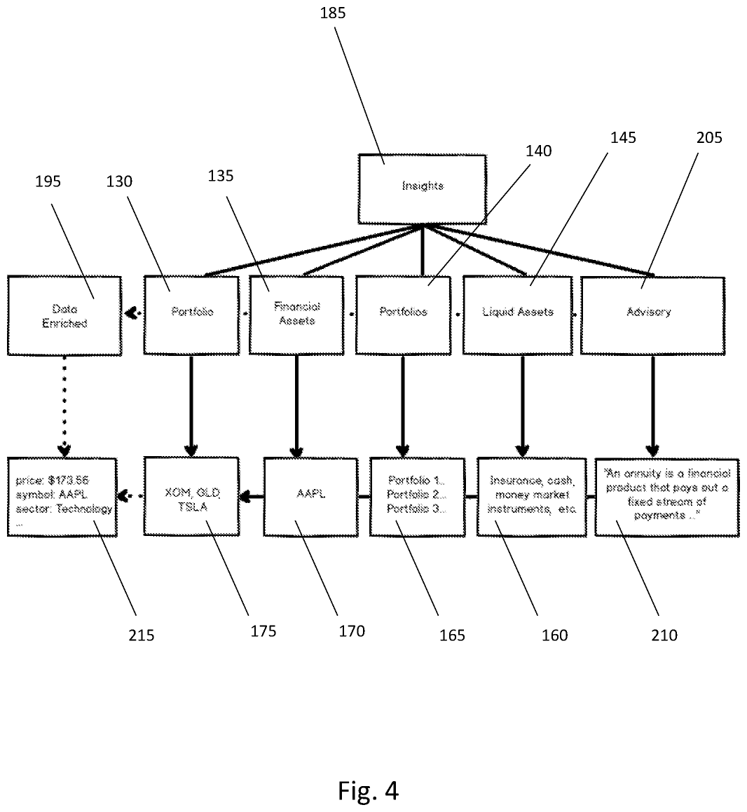

FIG. 4 shows a more detailed exploded view of constitutes insights 185 within the context of the method.

Insights 185, within the context of the method, are outputs 105 about assets that are financial by nature and contextually related to the inputs 100 which preceded them.

Insights 185 may be a portfolio 130, financial assets 135, portfolios 140, liquid assets 145, or advisory 205. Advisory 205 is described as a generic textual response of financial nature.

While insights 185 may contain advisory 205 about financial assets, they also may not. Insights 185 can be a portfolio 130, financial assets 135, portfolios 140, or liquid assets 145 by themselves or in conjunction with advisory 205 about them.

Examples of advisory 210, liquid assets 160, portfolios 165, financial assets 170, and portfolio 175 outputs are also provided. Any of these insights 185 can also further be data-enriched 195 by the method of which an example of a data-enriched financial asset 215 is shown.

While not shown in FIG. 4, anticipated variation of insights 185 may include physical assets, such as real estate, metals, heirlooms, commodities, fine art, cryptocurrencies, non-fungible tokens (NFTs), working interests, contracts, or intangible assets with an appraisable cash value, all of which could be data-enriched 195 by the method.

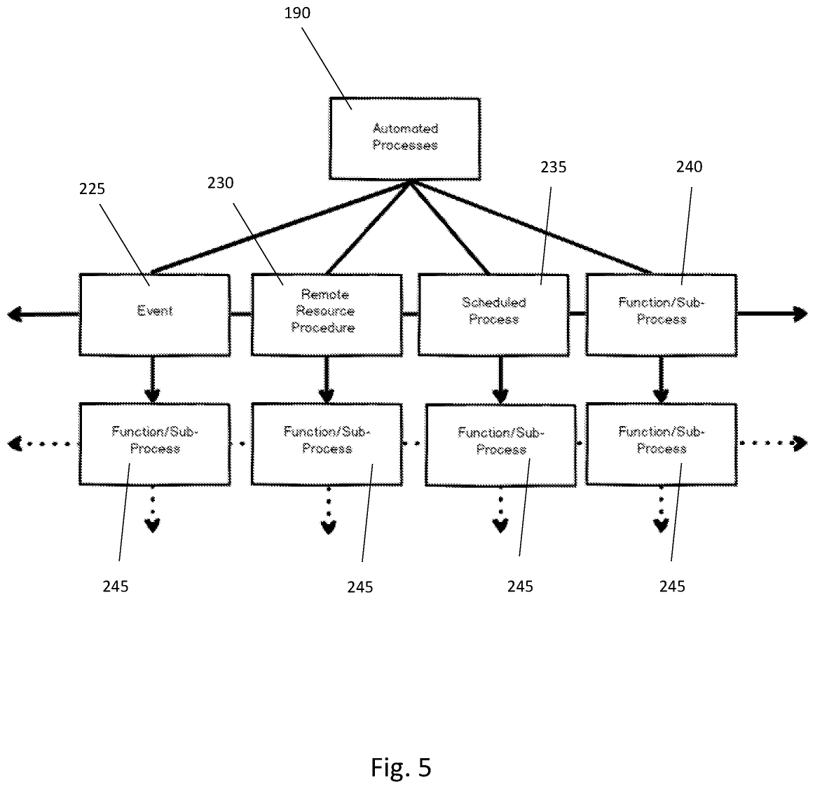

FIG. 5 depicts a more detailed view of what automatic or automated processes 190 may consist of within the context of the method. These processes may include a received event 225 by the method, a procedure executed on a remote resource 230, a scheduled process 235, or a simple function or sub-process 240. Each of these automatic processes may invoke other functions and sub-processes 245 within themselves. This workflow is common in an application programming interface (API) which may serve as the automatic processing module 115 of the system 630 implementing the method.

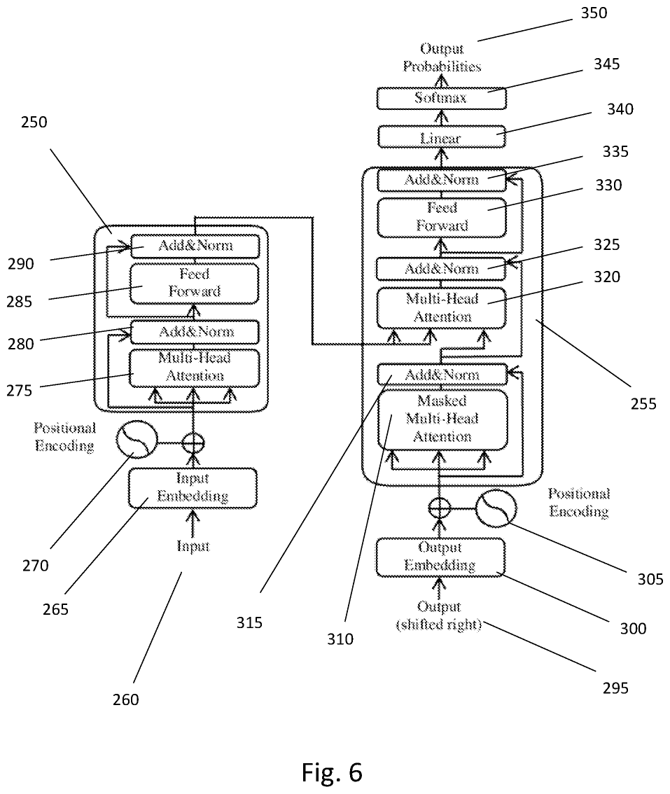

FIG. 6 shows an exploded and more detailed view of a machine learning model 110 which may be used by itself or as part of an ensemble of models within a system 630 implementing the method.

While any type of machine learning model 110 could be used, the diagram depicted is that of a transformer model. Such a machine learning model would utilize an encoder network 250 to take inputs 260 and convert them into input embeddings 265. Positional encoding 270 is then used indicate the location or position of an entity in a sequence so that each position is assigned a unique representation.

Embedded inputs then pass into a multi-head attention layer 275 which calculates an attention score to control the mixing of information between pieces of an input sequence in parallel computation.

The result is then passed off to an additive and normalization layer 280, which performs data manipulation to augment and remove extreme values. Additional feed-forward layers 285 and additive and normalization layers 290 are used before passing the results off to an output embedding network 255.

FIG. 6 shows how the results from the input embeddings network 250 enter an output embeddings network 255 via the masked multi-head attention layer 320 to optimize sequence predictions. The decoder model 255 receives the previous shifted-right output 295 from itself, augments it with positional encoding 305, and implements masked multi-head attention over it 310. The resultant embeddings flow into an additive and normalization layer 315 and then a multi-head attention layer 320 where an attention score is calculated and combined on embeddings sequences only up to the current position.

Resultant outputs then flow through more additive and normalization layers 325, a feed-forward network 330, additive and normalization layers 335, and then finally onto linear 340 and Softmax 345 activation functions, which result in output probabilities 350.

While the encoder model 250 is designed to attend to all words in the input sequence provided by the user (regardless of their position in the sequence), the decoder model 255 is modified to attend only to the preceding words, with the encoder model 250 feeding the decoder 255 learned attention from the whole sequence. This entire process helps to better optimize the output probabilities in context of the intent of the user's input.

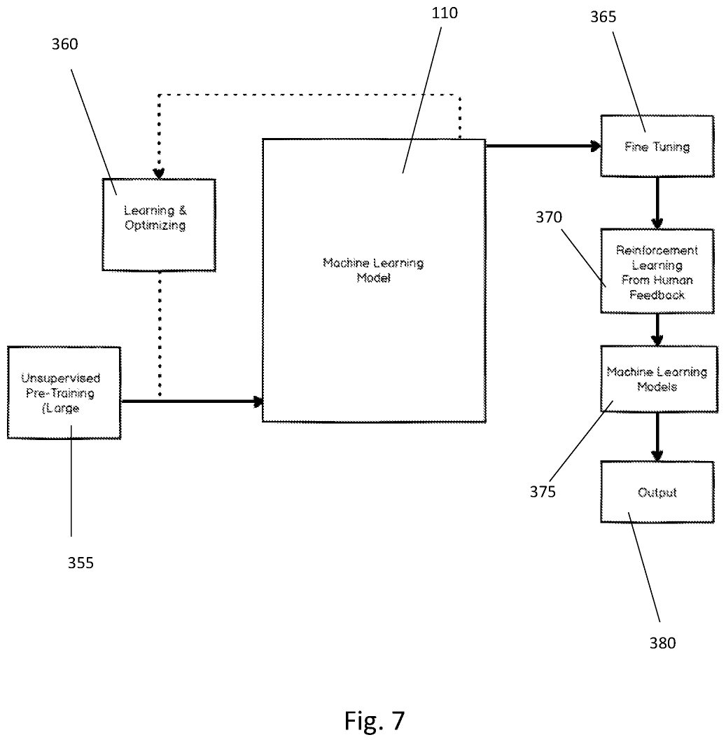

FIG. 7 shows how a variation on the prior machine learning model could be used where the machine learning model 110 is further augmented to use unsupervised pre-training 355, learning and optimization processes 360, fine tuning 365, reinforcement learning from human feedback 370, and additional machine learning models 375, which then deliver model outputs 380.

The important thing to note is that while the system does not require any machine learning models FIG. 6 and FIG. 7 depict that the system 630 implementing the method in the preferred embodiment can utilize any variation, ensemble of variations, or plurality of machine learning model 110.

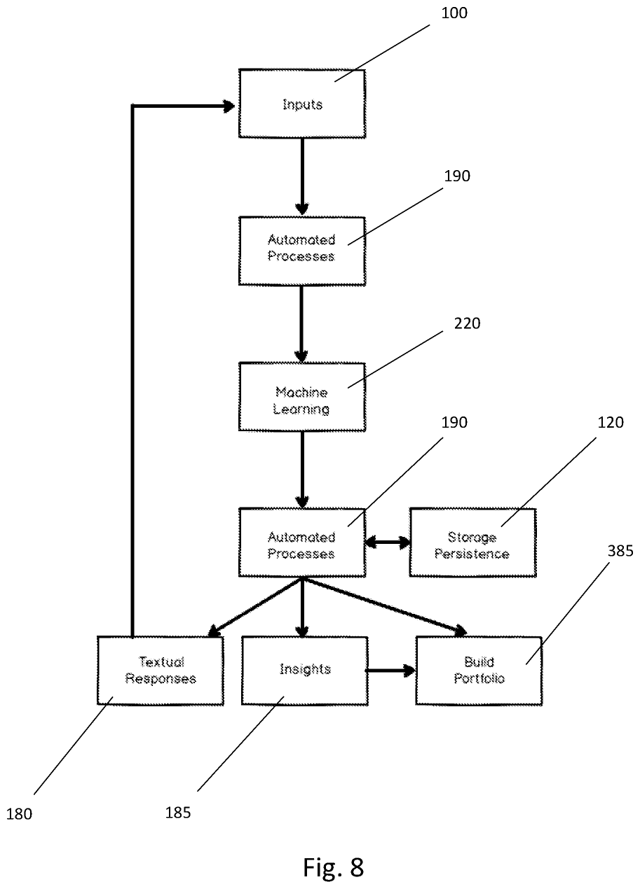

FIG. 8 is a flowchart which shows how inputs 100 are initiated by a user and move through a subsection of the method to become outputs 105.

Within FIG. 8 inputs 100 are received and flow through automated processes 190 which are prepared and passed through machine learning model 220. The results which are received back to automated processes 190 to prepare outputs 105 as insights 185 or textual responses 180, which are then persisted in storage 120 before being returned to the user.

Within the system 630 implementing the method in the preferred embodiment, automated processes 190 would be an API and storage persistence 120 would be a database or datastore of any type with the accompanying driver processes.

When insights 185 are delivered to the user, the user may be presented with the option to build portfolio 385, a specific process in which received insights 185 are further data-enriched 195 and presented back to the user in a quantitative visualized format.

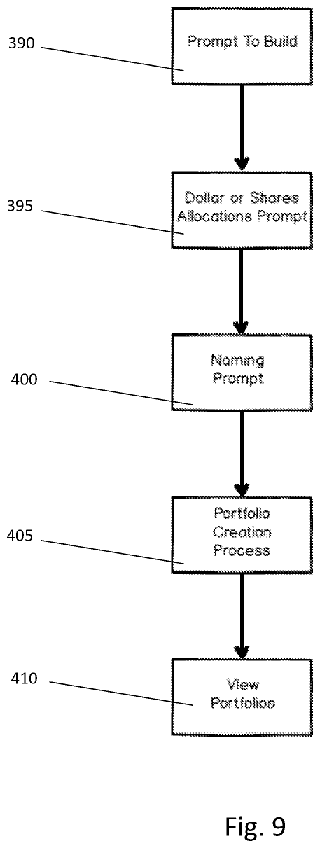

FIG. 9 further explodes out the build portfolio 385 process. First, the user receives a prompt to build 390 which they have the option of affirming or negating. If the user negates, the flow terminates-however if they affirm, they receive another prompt to enter a dollar value for the portfolio or number of shares to allocate to each position 395.

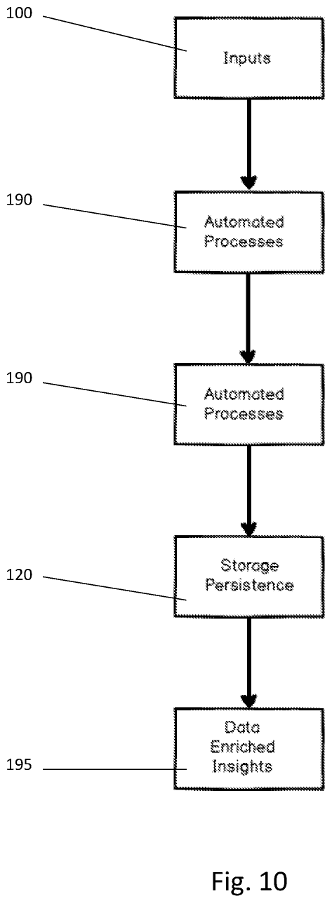

Upon entering the requested information, the user is presented with another prompt to name the portfolio 400, which then executes the portfolio creation process 405 further described in FIG. 10.

Upon completion of the portfolio creation process 405, the user is prompted to view their portfolios 410 or the created portfolio directly.

FIG. 10 further explodes out the portfolio creation process 405 which is a unique and key aspect of the method. During the portfolio creation process 405, inputs 100 as insights 185 pass into automated processes 190 which gather additional data about the insights, such as market data, news, and other information. Other automated processes 190 run a series of calculations which include allocating the correct number of shares or dollar amount to each position based on the information provided by the user previously 395. Upon completion of these automated processes 190, the data-enriched insights 195 are persisted in storage 120 and returned to the user for presentation.

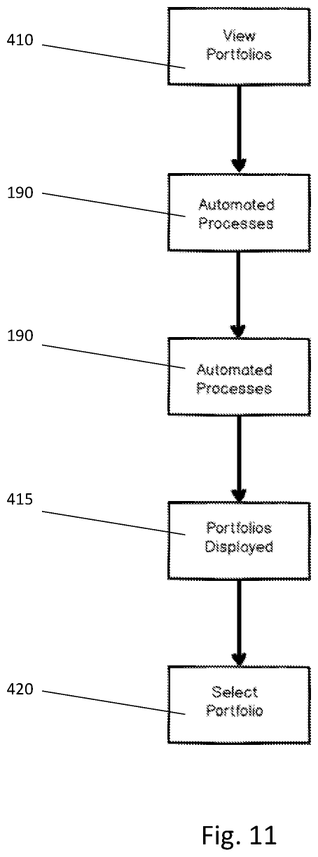

FIG. 11 shows an extension of the subsection of the method from FIG. 9. where the data-enriched insights 195 have been returned to the user and the user is prompted to view their portfolios 410. If the user negates this prompt, the flow terminates-however if they affirm, this executes a series of automated processes 190 where the data-enriched insights 195 are updated and presented to the user for display 415. These processes can include updating the market price during market hours, latest news, percentage gain or loss on each position, and other quantifiable metrics from the portfolio creation process 405.

From the displayed portfolios 415, the user can now select the generated portfolio 420.

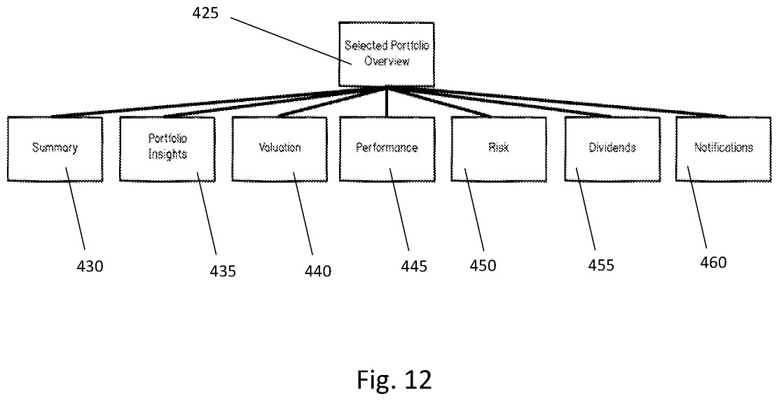

FIG. 12 depicts the presentational overview 425 of the data-enriched 195 portfolio 130 once the user has selected the portfolio 420. The preferred embodiment of the invention would include a variety of presentational modules and processes such as portfolio summary 430, insights 435, valuation 440, performance 445, risk 450, dividends 455, and notifications 460.

Selecting any one of these presentational modules executes automatic processes 190 specific to that presentational module. While these specific presentational modules are within the preferred embodiment, other presentational modules could be introduced that allow the data-enriched 195 portfolio 130 to be quantified, measured, modified, analyzed, manipulated, or monitored in different facets.

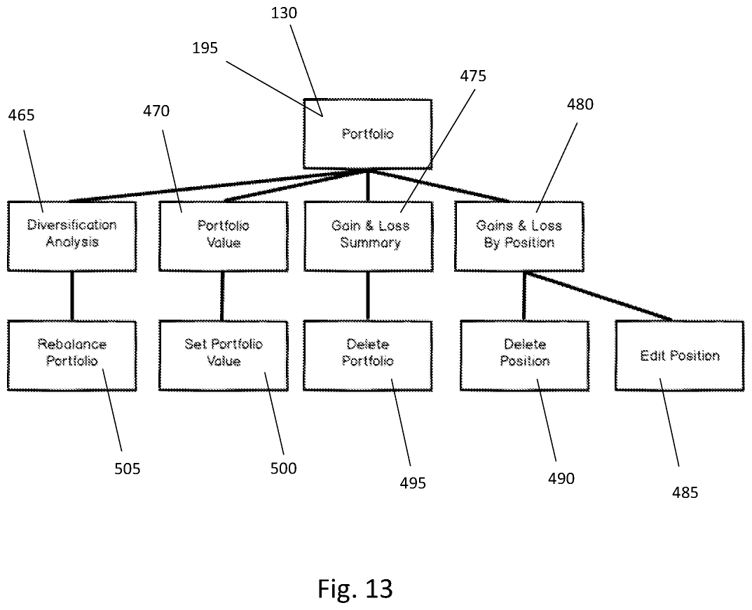

FIG. 13 shows an exploded view of the portfolio summary module 430 which contains additional automatic processes that can be applied to the data-enriched 195 portfolio 130 for computing a portfolio summary.

These specific automatic processes may include but are not limited to diversification analysis 465, portfolio value 470, portfolio gain & loss summary 475, gain & loss by position 480, edit position 485, delete position 490, delete portfolio 495, set portfolio value 500, and rebalance portfolio 505.

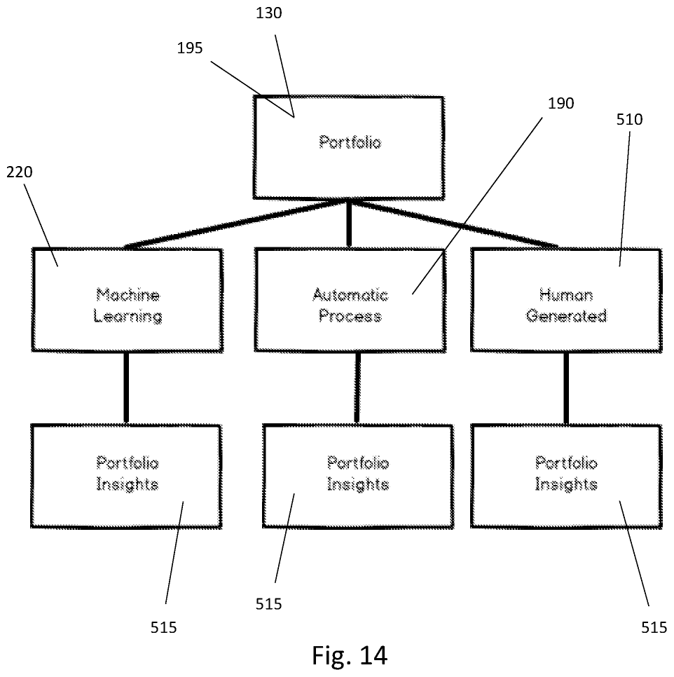

FIG. 14 shows an exploded view of the portfolio insights module 435 which contains additional automatic processes that can be applied to the data-enriched 195 portfolio 130. This presentational module further processes the data-enriched 195 portfolio 130 to generate portfolio insights 515 by use of machine learning 220, automatic processes 190, or human-generated process 510.

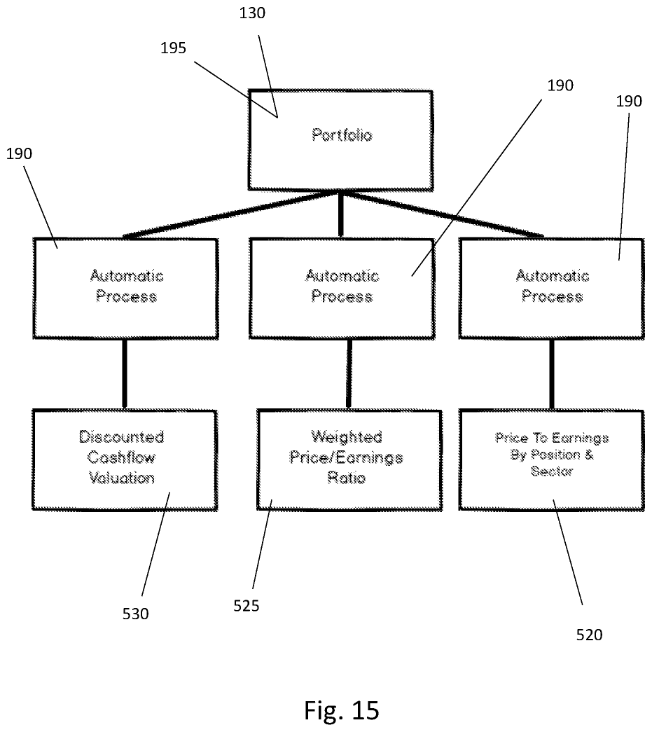

FIG. 15 shows an exploded view of the portfolio valuation presentational module 440 which contains additional automatic processes that can be applied to the data-enriched 195 portfolio 130. This presentational module further processes the data-enriched 195 portfolio 130 using automated processes 190 to generate quantitative valuation metrics such as price-to-earnings ratios by position & sector 520, weighted price-to-earnings ratio 525, and discounted cashflow valuation 530.

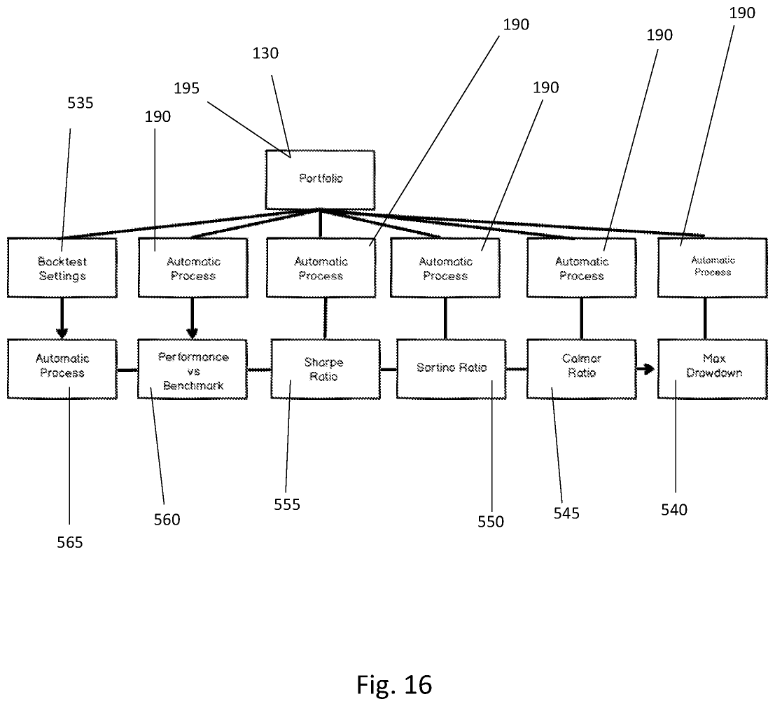

FIG. 16 depicts an exploded view of the portfolio performance presentational module 445 which contains additional automatic processes that can be applied to the data-enriched 195 portfolio 130. This presentational module further processes the data-enriched 195 portfolio 130 using automated processes 190 to generate performance metrics such as maximum drawdown 540, Calmar ratio 545, Sortino ratio 550, Sharpe ratio 555, and portfolio performance versus a market benchmark index 560. Additionally, a user can manipulate a plurality of backtest settings 535 and invoke additional automatic processes 565 to measure the performance of the data-enriched 195 portfolio 130 over different periods of financial history.

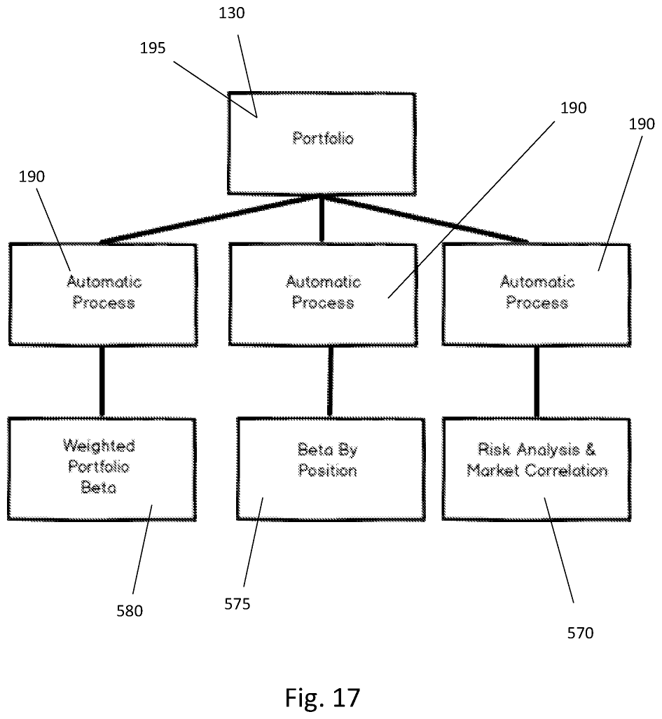

FIG. 17 shows an exploded view of the portfolio risk presentational module 450 which contains additional automatic processes that can be applied to the data-enriched 195 portfolio 130. This presentational module further processes the data-enriched 195 portfolio 130 to generate quantitative risk metrics such as risk analysis & market correlation 570, beta by position 575, and weighted portfolio beta 580.

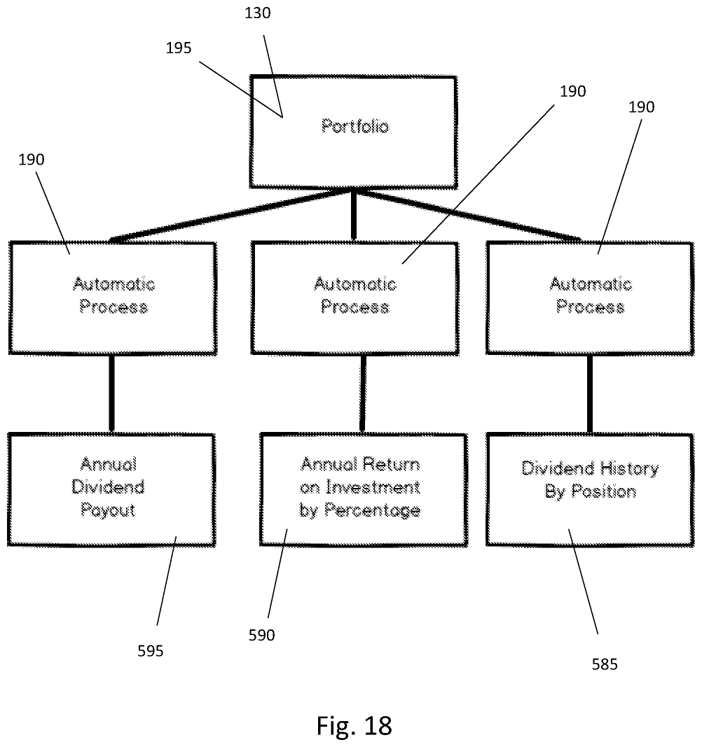

FIG. 18 shows an exploded view of the portfolio dividends presentational module 455 which contains additional automatic processes that can be applied to the data-enriched 195 portfolio 130. This presentational module further processes the data-enriched 195 portfolio 130 to generate quantitative dividend metrics such as dividend history by position 585, annual return on investment from dividend by percentage 590, and annual dividend payout 595.

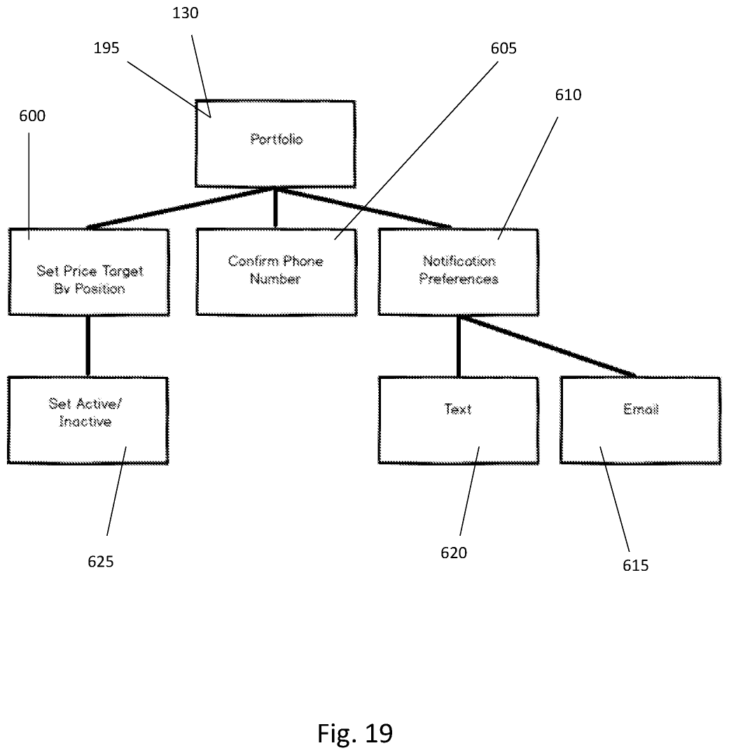

FIG. 19 shows an exploded view of the portfolio notifications presentational module 460 which contains additional automatic processes that can be applied to the data-enriched 195 portfolio 130. This presentational module further processes the data-enriched 195 portfolio 130 to generate notifications. Automatic processes that can be invoked in this presentational module include setting price target by position 600 which can further be set as active or inactive 625, confirming the user's phone number 605, and setting notification preferences 610 by email 615 or text 620.

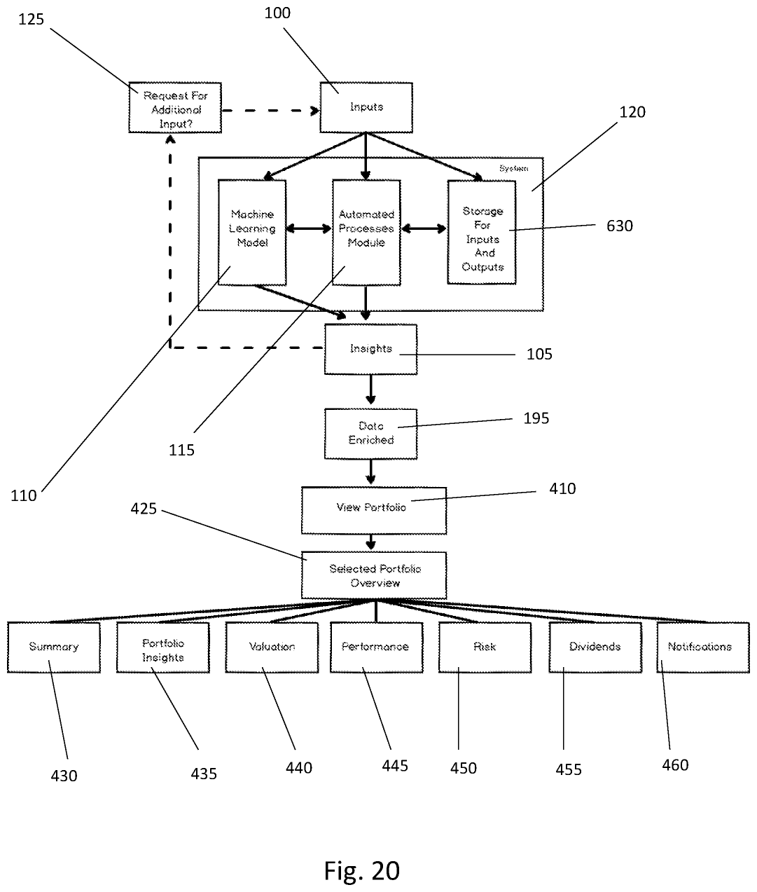

FIG. 20 shows a condensed summary of the invention, the method—implemented by the system 630 comprising of a machine learning model 110, automatic processes module 115, and storage persistence for inputs and outputs 120—which accepts inputs 100 to generate insights 185.

At the request of the user, generated insights 185 can then be data-enriched 195 and returned to the user as a data-enriched 195 portfolio 130 in a quantitative format 410 by presentational modules once selected 425. The presentational modules may include—but are not limited to—a portfolio summary module 430 and additional presentational modules, utilized to generate portfolio insights 435 and metrics for valuation 440, performance 445, risk 450, dividends 455, and notifications 460.

What is claimed is:

1. A method for generating, presenting, and processing an investment portfolio, comprising of:
receiving inputs from a user or external source regarding investment criteria or financial inquiry via an interface;
generating insights via machine learning or automatic process;
generating an investment portfolio from said insights;
building the generated investment portfolio;
enriching the generated investment portfolio with data; and
presenting the generated investment portfolio back to the user.

2. The method of claim 1, further comprising automatic processing for computing a portfolio summary, portfolio insights, valuation metrics, performance metrics, risk metrics, dividend metrics, and notifications over the life of the investment portfolio.

3. The method of claim 1, wherein the inputs include one or more of the following elements: (a) textual command, (b) inquiry, (c) portfolio, (d) financial asset, (e) liquid asset, (f) physical asset, (g) intangible asset of appraisable cash value, or some combination of (a), (b), (c), (d), (e), (f), and (g).

4. The method of claim 1, wherein the generated insights include one or more of the following elements: (a) advisory, (b) portfolio, (c) financial asset, (d) liquid asset, (e) physical asset, (f) intangible asset of appraisable cash value, or some combination of (a), (b), (c), (d), (e), and (f).

5. The method of claim 1, further comprising utilizing natural language processing to generate insights.

6. The method of claim 1, further comprising of notifying the user as investment portfolio metrics and market prices of the contained assets fluctuate.

7. The method of claim 1, wherein inputs are represented by the user via natural language, documents, images, or data exchange.

8. A system for generating, presenting, and processing an investment portfolio, comprising of:
an interface for receiving inputs from a user or external source;
a machine learning model or automatic processing module for generating insights;
an automated processes module for building generated portfolios, and processing inputs and outputs;
a storage medium for storing and retrieving inputs, outputs, or other data; and
an interface for user interaction and presentation of generated investment portfolios.

9. The system of claim 14, wherein the interface for user interaction and presentation further comprises of a summary module for quantifying, modifying, and displaying portfolio metrics.

10. The system of claim 14, wherein the interface for user interaction and presentation further comprises of a valuation module for quantifying asset and portfolio valuation metrics.

11. The system of claim 14, wherein the interface for user interaction and presentation further comprises of an insights module for generating insights as portfolio metrics and market prices of assets fluctuate.

12. The system of claim 14, wherein the interface for user interaction and presentation further comprises of a performance module for quantifying asset and portfolio performance metrics.

13. The system of claim 14, wherein the interface for user interaction and presentation further comprises of a risk module for quantifying asset and portfolio risk metrics.

14. The system of claim 14, wherein the interface for user interaction and presentation further comprises of an income module for quantifying asset and portfolio income.

15. The system of claim 14, wherein the interface for user interaction and presentation further comprises of a notifications module for tracking changes in market prices and portfolio metrics and providing notifications to the user.

16. The system of claim 14, wherein the interface for receiving inputs from a user or external source enables the user to enter inputs using the following: (a) natural language, (b) documents, (c) images, (d) data exchange, or some combination of (a), (b), (c), and (d).

17. The system of claim 14, wherein the interface for receiving inputs from a user or external source enables the user to receive the following: (a) textual responses, (b) automated processes, (c) advisory, (d) insights, or some combination of (a), (b), (c), and (d).
